(19) United States
(12) Patent Application Publication
(10) Pub. No.: US 2013/0000785 A1
(43) Pub. Date: Jan. 3, 2013

(54) LOG SPLITTER WITH TWO HANDED OPERATION FEATURES

(75) Inventors: Daniel Banjo, Boulder, CO (US); Jonathan Harrach-Salazar, Erie, CO (US)

(73) Assignee: BLOUNT, INC., Portland, OR (US)

(21) Appl. No.: 13/486,998

(22) Filed: Jun. 1, 2012

Related U.S. Application Data
(60) Provisional application No. 61/492,286, filed on Jun. 1, 2011.

(51) Int. Cl. B27G 21/00; B27L 7/06

(52) U.S. Cl. 144/366; 144/193.1

(57) ABSTRACT

Embodiments herein provide systems, devices, and methods for splitting logs, wood, and other materials. A splitting device safety feature is disclosed, the safety feature comprising a safety locking mechanism that generally requires operation or activation by at least one hand of a user and an activation mechanism which generally requires activation or use with the other hand of a user. Both mechanisms are required to be activated, each by at least one hand of a user, in a simultaneous manner in order to activate at least some features. For example, a safety lock out mechanism is provided that prevents or blocks the activation of the device from initiating log splitting processes. Therefore, two distinct features requiring the use of at least one hand of a user are required to be activated or operated in order to perform log splitting functions.

### CROSS REFERENCE TO RELATED APPLICATIONS

The present application claims priority to U.S. Provisional Patent Application No. 61/492,286, filed Jun. 1, 2011, entitled “Log Splitter with Two Handed Operation Features,” the entire disclosure of which is hereby incorporated by reference in its entirety.

### TECHNICAL FIELD

Embodiments herein relate generally to devices for splitting logs and wood. More specifically, embodiments relate to log splitters comprising features that require two handed actuation of the log splitter to improve overall safety.

### BACKGROUND

There currently exist many known structures for splitting logs. Structures and devices known for splitting logs include horizontal arrangements, vertical arrangements, hydraulic driven devices, mechanically driven devices, and various combinations thereof.

Examples of such devices include: U.S. Pat. No. 4,116,251 to Graney, U.S. Pat. No. 4,176,698 to Ahlschlager et al., U.S. Pat. No. 4,258,764 to Gerst, U.S. Pat. No. 4,378,825 to Schroeder, U.S. Pat. No. 4,463,787 to Lenertz, U.S. Patent Application Publication No. 2010/0024919 to Majkrzak, and U.S. Patent Application Publication No. 2009/0229709 to Babcock, all of which are incorporated by reference herein in their entireties.

Various devices known in the art for splitting logs are capable of producing high speeds and/or significant amounts of kinetic energy. However, known devices generally fail to provide various safety measures and features adapted to increase the safety of the device in operation. More specifically, many known devices are adapted for initiating log-splitting activities with minimal user input. Accordingly, known devices may present hazardous situations including, but not limited to, situations where a user need not remove appendages from harms way before initiating log-splitting activities.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 illustrates a log splitter in accordance with various embodiments.

FIGS. 2A-2D illustrate exploded (2A) and assembly (2B-2D) views of a safety lock out mechanism in accordance with various embodiments.

FIGS. 3A and 3B illustrate exploded (3A) and assembly (3B) views of a safety lock out mechanism in accordance with various embodiments.

FIGS. 4A-4C illustrate a portion of a log splitter in partially assembled views (4A and 4B) and an exploded view (4C) in accordance with various embodiments.

FIGS. 5A-5C illustrate various internal views of a portion of a log splitter in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Embodiments herein provide novel devices, systems, and methods for splitting logs, wood, and other materials suitable for use within splitting devices. In one embodiment, a splitting device safety feature is disclosed, the safety feature comprising a safety locking mechanism that generally requires operation or activation by at least one hand of a user and an activation mechanism which generally requires actuation or use with the other hand of a user. In one embodiment, both mechanisms are required to be actuated, each by at least one hand of a user, in a simultaneous manner in order to activate at least some features. For example, in one embodiment, a safety lock out mechanism is provided that prevents or blocks the activation of certain log splitting processes. Therefore, in this embodiment, two distinct features requiring the use of at least one hand of a user are required to be actuated or operated in order to perform log splitting functions.

Thus, in an embodiment, a log splitter is provided comprising a safety release member operable by a first hand of a user; and a splitter activation member operable by a second hand of the user, wherein operation of both the safety release member and the splitter activation member are required to enable performance of log splitting operation of the log splitter. In embodiments, the safety release member and the splitter activation member each comprise a user actuable element, wherein the user actuable elements are separated from each other a distance sufficient to prevent one-handed operation of both the safety release member and the splitter activation member.

One of ordinary skill in the art will recognize that log splitting devices of various types, but particularly those of the mechanical energy variety, are capable of propelling and/or translating various components and/or materials at high rates of speed. One of skill in the art will further recognize that these capabilities, while providing various benefits for splitting logs and other materials also present potentially hazardous operating conditions for users. It will be recognized that safe operation of these devices requires various items, including but not limited to human body parts, to remain clear from the areas and features used for splitting material. Therefore, in various embodiments, distinct lock out and activation devices are disposed at a location generally distal from (away from) portions of the device in which splitting operations occur. In embodiments, a safety release member and a splitter activation member may each comprise a user actuable element, the user actuable elements separated from each other a distance sufficient to prevent one-handed operation of both the safety release member and the splitter activation member. For example, in one embodiment, a safety lock out feature (safety release member) and a splitter activation member are separated by a distance of at least approximately twelve inches, a distance generally known to be larger than the reach of any single human hand. However, those of skill in the art will recognize that the embodiments herein are not limited to any specific arrangement of components and these distances may vary widely based on various design criteria.

In one embodiment, features necessary for activation of the devices are not only disposed sufficiently distant from one another, but are also disposed at a location whereby a user in contact or communication with the devices will be located at a safe and appropriate distance from splitting members (wedge, anvil, track, etc.). Accordingly, in various embodiments, operation of a log splitter not only requires a user to employ both hands to activate moving features, but further requires that the user be located at a position whereby body parts, clothing, and similar items are positioned at a safe location/distance away from driven or moving members.

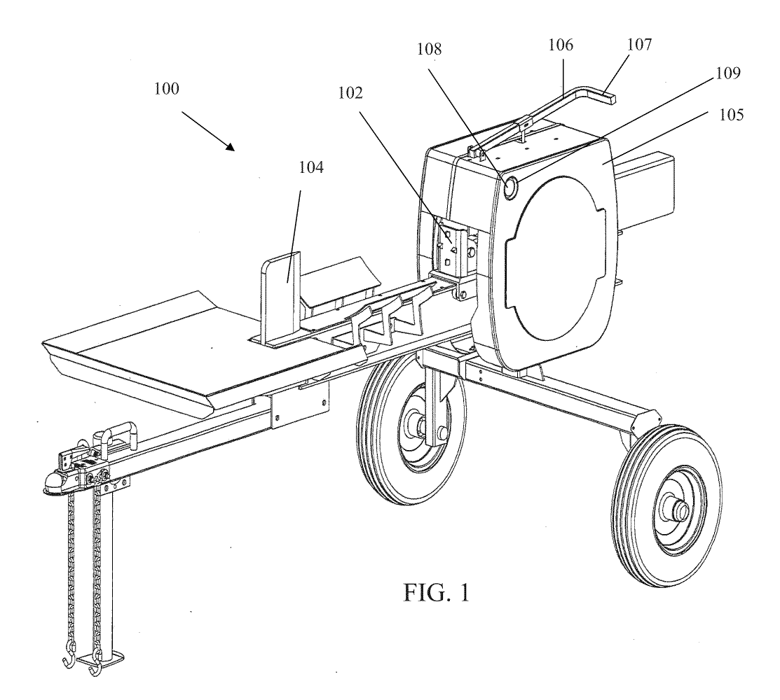

FIG. 1 illustrates a log splitter 100 in accordance with various embodiments. Log splitter 100 comprises a driven member or anvil 102 for driving a piece of material such as a log into/onto a wedge 104 adapted for splitting material. Also provided are a drive release member 106 for converting and/or imparting energy from one or more components of the system to the driven member 102, and at least one safety release member 108 that is required to be actuated in order to permit actuation of a drive release member 106 and subsequently transmit energy and force to driven member or anvil 102. Drive release member 106 includes a user-actuable element, namely handle 107. Safety release member 108 includes a user-actuable element, namely the accessible/visible push knob or button.

In one embodiment, the safety release member comprises a recessed push button that is biased in an outward direction. When biased in an outward direction or position, a safety release member and other elements coupled thereto are adapted to substantially prevent or impede the movement of a drive release member. Accordingly in various embodiments, a drive release member is rendered stationary or “locked out” in the absence of activation of the safety release member. Furthermore, in one embodiment, the drive release member comprises the only means or device for activating a driven member. Accordingly, in such an embodiment, it will be recognized that both a safety release member and a drive release member must be activated at the same time in order to operate a driven member and conduct log splitting or similar operations with the device.

Various components may be contained within a housing 105 that generally isolates certain system components from environmental conditions and human interaction or contact. In one embodiment, safety release member 108 is accessible through an aperture 109 formed in housing 105. Safety release member 108 may be recessed a certain distance within aperture 109 in order to prevent or reduce the risk of tampering and/or accidental contact with safety release member 108. In various embodiments, housing 105 may comprise removable fasteners, latches, doors, and/or louvers for providing access to various internal system components which may require cooling, maintenance, replacement, and various combinations thereof.

In FIG. 1, drive release member 106 is oriented such that the handle 107 or user-proximal portion of the member/lever is positioned toward a rearward portion of log splitter 100. In such embodiments, a user and more particularly a user's hand is positioned distal to log splitting operations and/or moving features of the device. In alternative embodiments, handle 107 may be positioned toward a forward portion of log splitter 100, or may be positioned to one side. It will be expressly recognized that safety release member 108 may similarly be positioned at or near a rearward portion of log splitter 100. In embodiments, additional guards or shields may be included to make access to one or both of the safety release member and the drive release member difficult except when the user is positioned at a safe operating location.

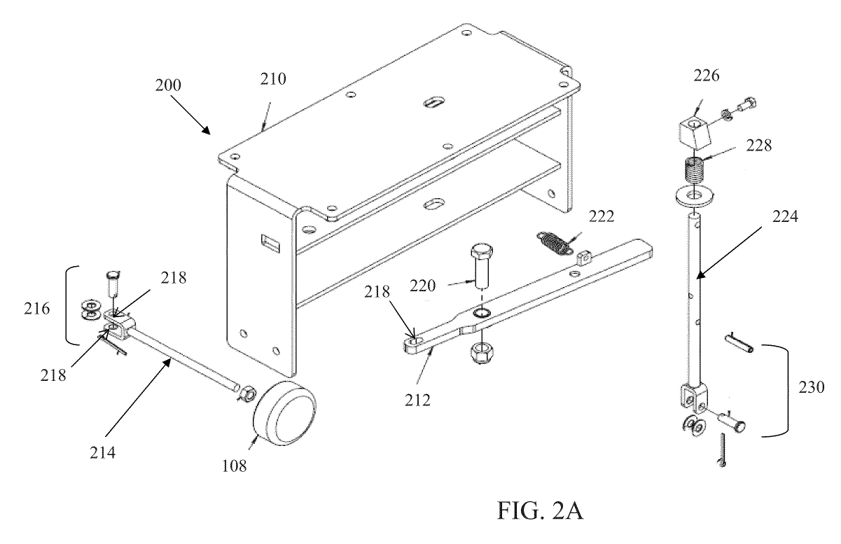

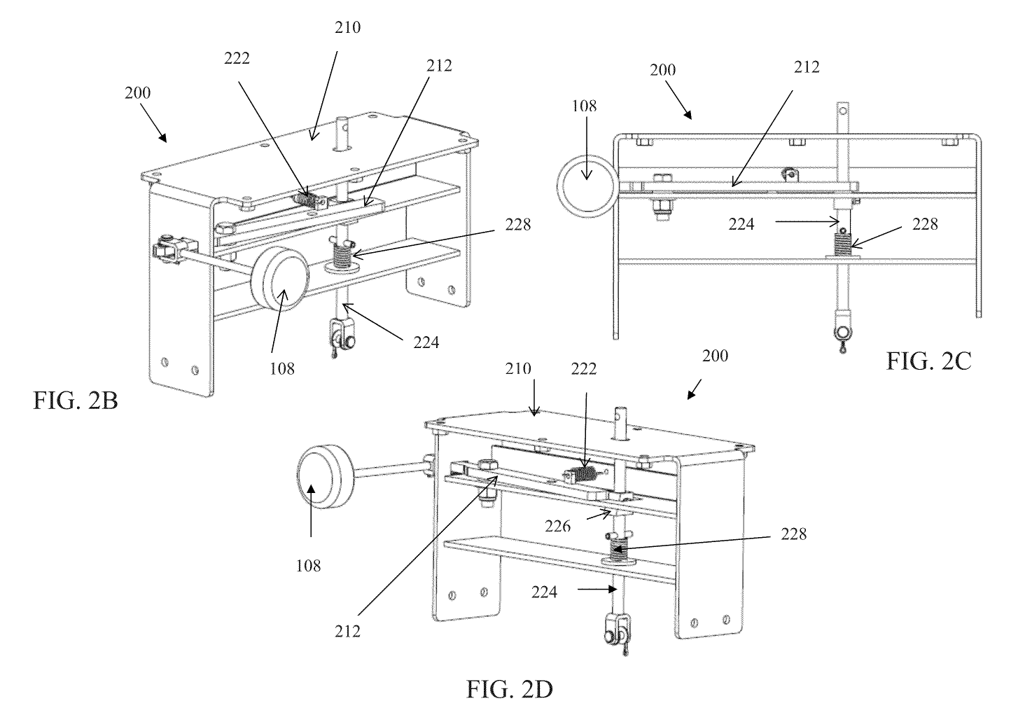

FIGS. 2A-2D illustrate exploded (2A) and assembly (2B-2D) views of a safety lock out mechanism 200 in accordance with various embodiments. A safety lock out mechanism 200 comprises a platform 210 for containing, attaching, and/or organizing various features. Platform 210 contains or is generally connected to a lock member 212 that is activated or operated by safety release member 108 (such as a push knob) and a lock out shaft 214. In an embodiment, safety release member 108 and lock out shaft 214 are connected to lock member 212 via pin connection/coupling 216 through one or more apertures 218 in the lock out shaft and/or lock member. Accordingly, pin connection/coupling 216 enables the transmission and/or translation from linear movement applied to lock out shaft 214 via safety release member 108 to angular rotation of lock member 212. Lock member 212 may be additionally hinged by a hinge member or locking pin 220 that allows for rotation of lock member 212 about the hinge member or locking pin 220. Additionally, lock member 212 and interconnected lock out shaft 214 and safety release member 208 may be biased in a particular direction based at least in part on the attachment to biasing member 222.

In embodiments, biasing members may refer to a variety of linearly and non-linearly biased members including, but not limited to, coil springs, leaf springs, elastomeric members, hydraulic members, and various other similar devices as will be recognized by one of ordinary skill in the art.

Lock member 212 is angularly rotatable between a first position and a second position. In a first position, lock member 212 provides for a barrier or interference for the movement of a drive release shaft 224. For example, when the safety release member 108 is in a non-actuated or non-depressed position, the corresponding position of lock member 212 will be such that contact is made between a lower portion of lock block 226 attached to drive release shaft 224 and an upper portion of lock member 212. Accordingly when safety release member 108 is not activated, lock member 212 is disposed such that movement of a drive release member (such as drive release member 106 in FIG. 1) and a drive release shaft 224 are prevented due to contact between at least lock block 226 and lock member 212. Accordingly, activation of log splitting features is prevented so long as safety release member 108 is not depressed.

In one embodiment, drive release shaft 224 is connected to a drive release member (for example, drive release member 106 in FIG. 1), the drive release member being disposed external to a housing (for example, housing 105 in FIG. 1). In various embodiments, drive release shaft 224 and an associated drive release member are biased in an upward or disengaged position due to a drive release biasing member 228.

A drive release biasing member may be comprised of any number of suitable features as will be recognized by one of ordinary skill in the art. Such features include, but are not limited to, coil springs, elastomeric materials, leaf springs, hydraulic members, and various other similar devices. For the purposes of the present disclosure, bias and/or biasing may refer to a linearly or non-linearly biased member. One of skill in the art will recognize that in various applications, use of either a linearly biased and/or non-linearly biased member may be appropriate.

In various embodiments, drive release shaft 224 is in communication with a drive release member at a first end and in communication via a pin connection/coupling 230 with various additional components at a second end for converting rotational energy to linear kinetic energy. One of skill in the art will recognize various devices, means, and methods for imparting rotational energy (e.g. energy contained in rotating inertial fly wheels) to a linearly driven rack or slide. For example, various features are shown and described in U.S. Pat. No. 4,116,251 to Graney, which is hereby incorporated by reference in its entirety herein.

In one embodiment, a lock out mechanism may comprise a first or disengaged position. This first position may be generally characterized by a safety release member and lock out shaft being in an outward or non-actuated (un-activated) position, a lock member being disposed at a radial position suitable for locking or preventing movement of a drive release shaft, and a lock block being disposed such that it is preventing communication with the lock member. For example, in one embodiment, the drive release shaft and associated components are positioned in an upward or first position whereby the drive member and linearly driven components are not engaged. Furthermore, in this first position a lock block is disposed such that attempts at linear movement of the drive release shaft via the drive release member are prevented due to contact and normal forces applied between a lock member and a lock block.

In various embodiments, a second position is contemplated. The second position being generally characterized by the safety release member and associated lock out shaft being disposed in an actuated or depressed position, and the lock member being hingedly connected and rotated to a second position such that the lock member does not prohibit or interfere with the linear movement of a drive release shaft and a lock block. Thus, in this second position, the actuation of the safety release member provides for the ability to subsequently and/or simultaneously activate a drive release member with a force sufficient to overcome the spring force provided by the drive release biasing member. It will be recognized that where the lock member has been rotated to a second position, movement of the drive release shaft will be generally unobstructed by the lock member, thus allowing for actuation of a drive release member and allowing a drive release shaft to activate additional features of the log splitter.

In one embodiment, a drive release shaft comprises a lock block that is tapered or shaped such that the lock block and connected drive release shaft may be returned to an original position without substantial interference from a lock member. For example, the drive release shaft may be returned to an original or upward position due to a force imparted by the drive release biasing member and/or an upward force applied to the drive release member. Accordingly, a lock block comprising at least one tapered or asymmetric surface does not substantially prevent the movement of a drive release shaft in an upward direction, yet does prevent the undesired downward movement of the drive release shaft. Accordingly, as will be recognized by one of skill in the art, a safety release member necessitating activation by at least one hand of a user and a drive release member additionally necessitating activation by at least one hand of a user are provided. Features as described herein thereby increase the overall safety of the device by requiring a user to operate the device with two hands and necessarily keeping both arms and hands away from splitting portions of the device. Additionally, the risk of accidental actuation of log splitting features, such as presented by falling objects, inattentive users and bystanders, and various other unforeseen circumstances is substantially reduced due to the complexity required to activate the device.

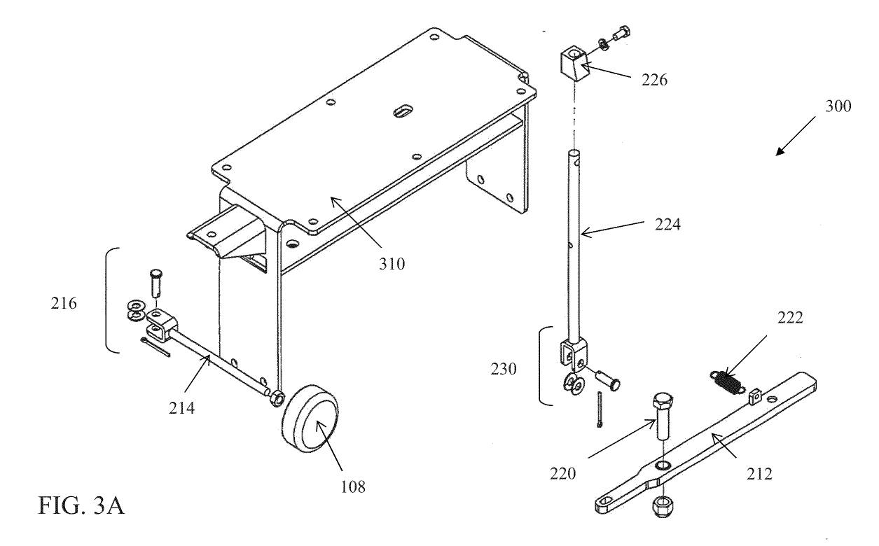

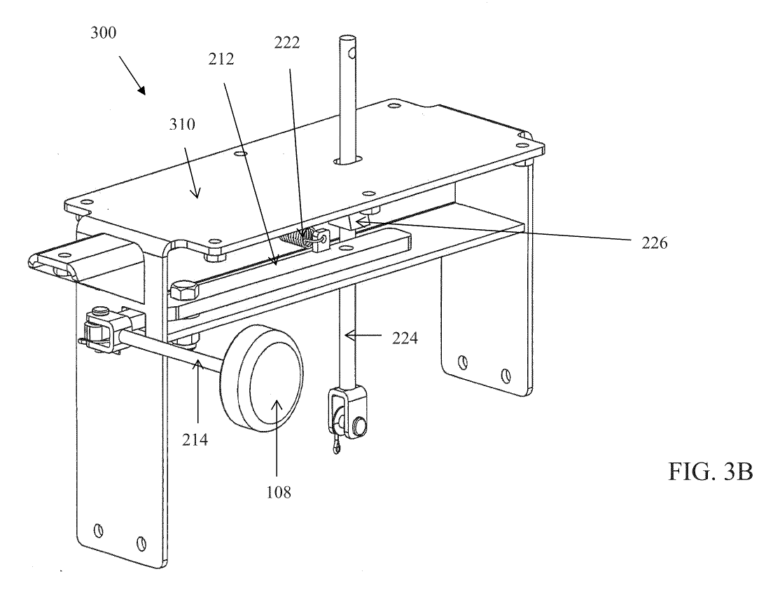

FIGS. 3A and 3B illustrate exploded (3A) and assembly (3B) views of an alternative safety lock out mechanism 300 in accordance with various embodiments. A safety lock out mechanism 300 comprises a platform 310 for containing, attaching, and/or organizing various features in the same or similar manner shown in FIGS. 2A-2D.

Components described herein may be constructed from any suitable material(s). For example, materials and equivalents specified in the ASM Worldwide Guide to Equivalent Irons and Steels may be utilized. Additionally, various synthetics and plastics may be utilized for any number of parts and components so long as desired rigidity, sheer strength, bending strength, and/or additional material properties are satisfied.

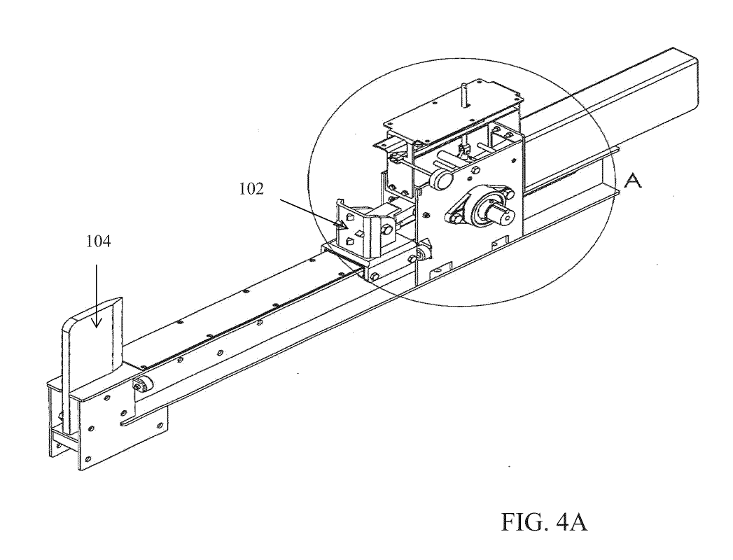

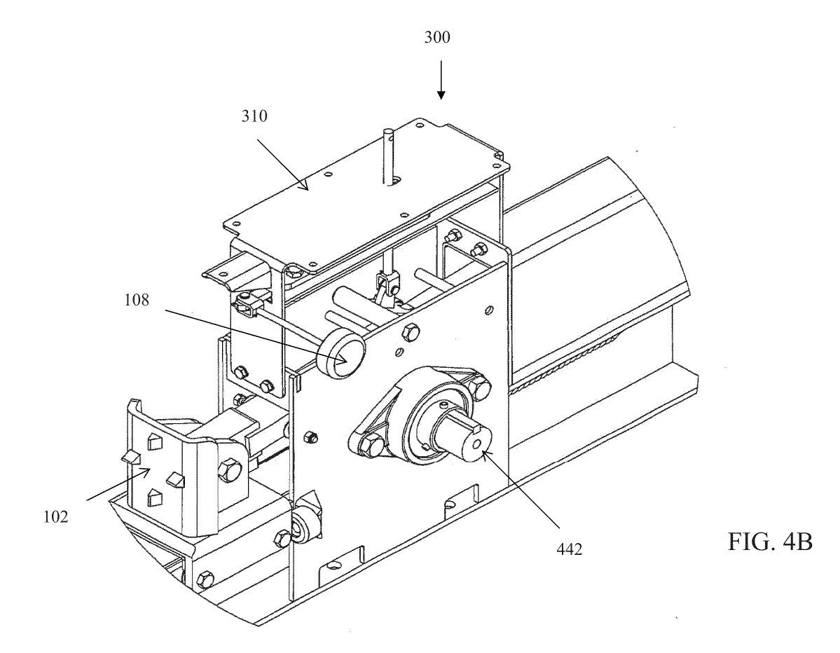

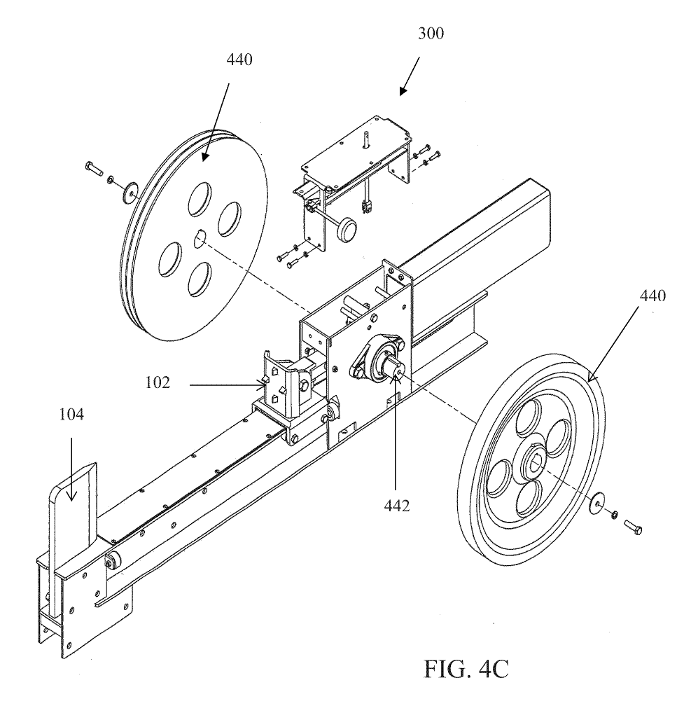

Referring now to FIGS. 4A-4C, a portion of a log splitter is shown in partially assembled views (4A and 4B) and an exploded view (4C). FIG. 4C is a detail view of section “A” identified in FIG. 4A. Safety lock out mechanism 300, previously described, is shown with respect to and in attachment with additional components. Stationary wedge 104 and movable anvil 102 are illustrated. As shown in FIG. 4C, inertial fly wheels 440 are provided for mounting on fly wheel mounts 442 and which may be utilized to store kinetic energy generated by a motor, such as a gas driven motor. The energy stored within the angular momentum of fly wheels 440 may be isolated from certain log splitting features in a first position of use. This inertia may subsequently be accessed or imparted upon linearly driven log splitting devices through the use of the previously described safety release member 108 and drive release member 106. For example, when the safety release member 108 and drive release member 106 are appropriately actuated, downward displacement of a drive release shaft 224 may be achieved. The downward displacement subsequently activates various features to engage linear drive members and move a log toward a splitting wedge (or conversely move the wedge toward a log).

In embodiments, fly wheels of various dimensions and weights may be attached to the devices described herein via the fly wheel mount and powered by various known devices.

In one embodiment, log splitting operations are conducted using a log splitting device in accordance with embodiments herein. Initially, a log to be split is placed in a desired location between a drive member and an anvil. Subsequently, a user applies pressure to a safety release button and, while maintaining the safety release button in a depressed state, engages the drive release member/lever. When the drive release member is engaged, the drive member will impart energy to a log, driving and splitting the log against the anvil using a static wedge. Finally, log segments are removed from the device, if necessary, and the device is restored to an initial position where it is capable of carrying out additional log splitting activities.

Although certain embodiments herein describe/depict an anvil being disposed on a translatable portion of the device and a static splitting wedge disposed opposite thereto, one of ordinary skill in the art will recognize that embodiments herein are not limited in this manner. Indeed, it is contemplated that the splitting wedge may be attached or connected to the linearly driven member and disposed opposite a stationary anvil.

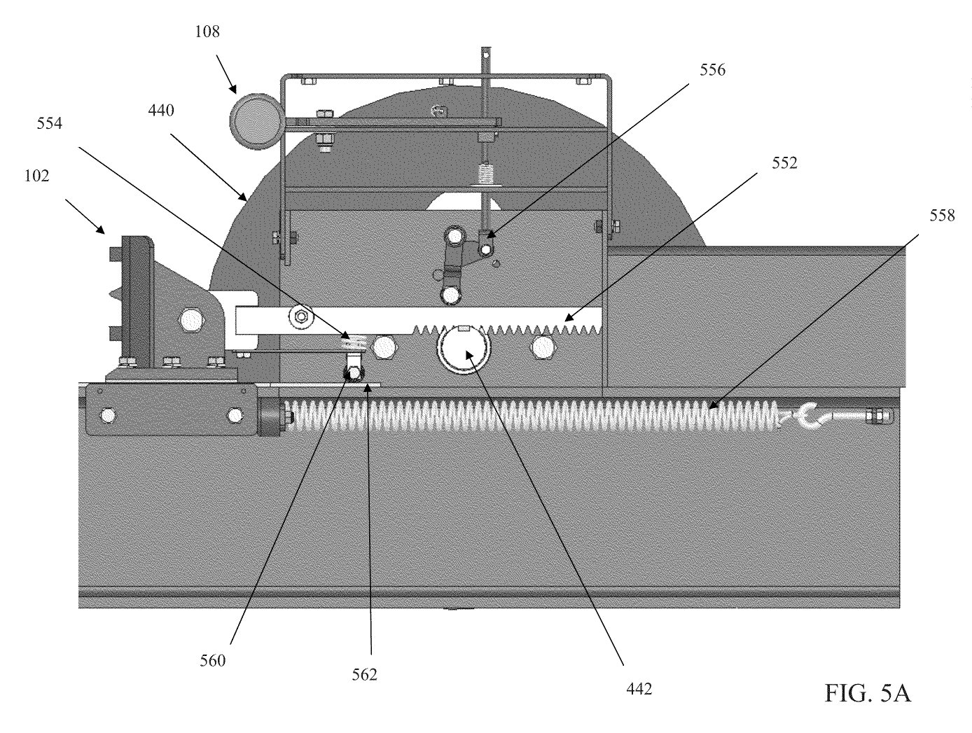

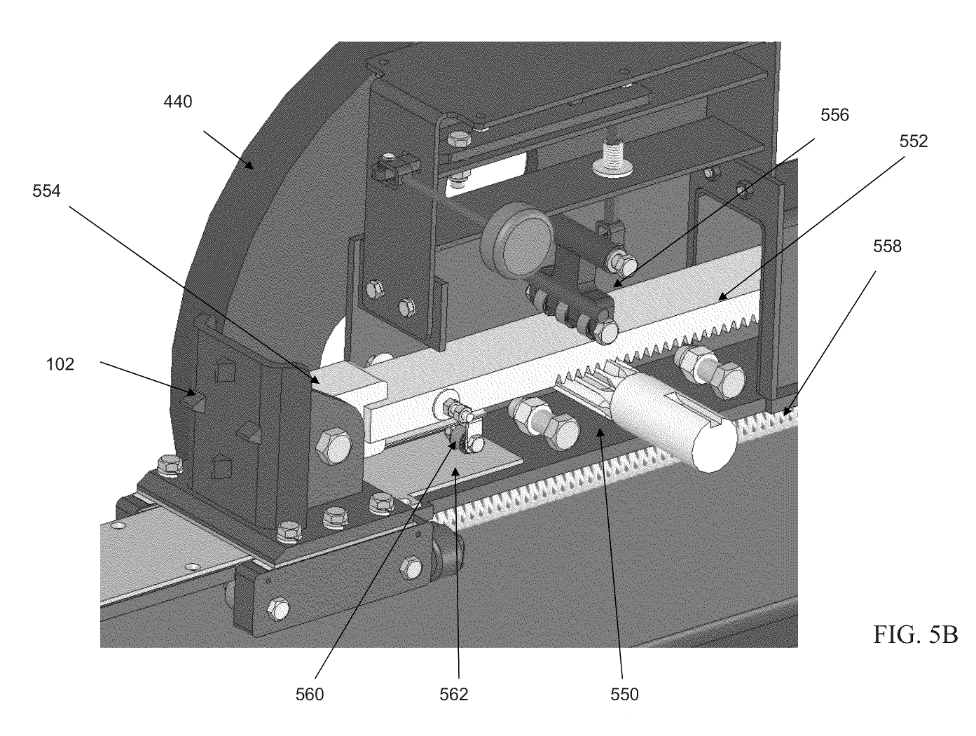

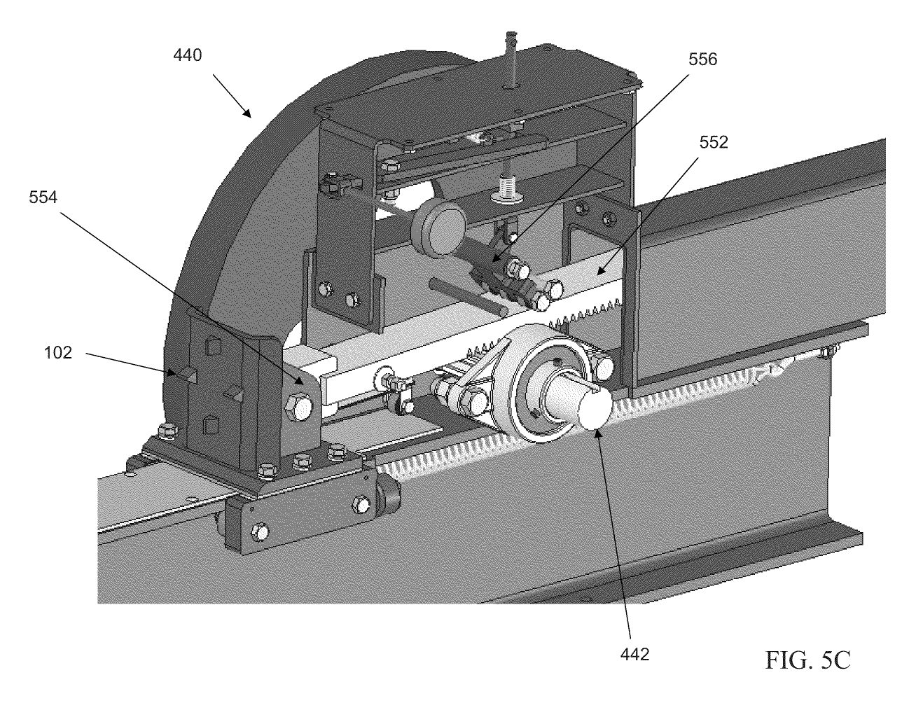

FIGS. 5A-5C illustrate various internal views of a portion of a log splitting device in accordance with various embodiments. More specifically, FIGS. 5A-5C provide partial cross-sectional views wherein only one fly wheel 440 is shown. A drive gear 550 is operably connected to one or more fly wheels 440, which may be powered by an engine, such as a gas engine. In order to transfer kinetic energy from fly wheel(s) 440 to the anvil 102, a rack 552 in hinged communication with anvil 102 is provided. As shown, rack 552 is biased in an upward or disengaged position by a rack spring 554. Thus, absent user interaction, the moving fly wheel(s) 440 and drive gear 550 are free to rotate without displacing or affecting the position of anvil 102. In an embodiment, a drive release member must be depressed or moved in a downward direction to activate features of the device as shown. However, one of skill in the art will recognize that activation of various features may be accomplished in a variety of ways. For example, in alternative embodiments, it is contemplated that a drive release member may move upward, laterally, or in various combinations of directions in order to activate log splitting operations.

Upon selective activation of safety release member 108 and drive release member, rack 552 may selectively engage drive gear 550. Accordingly, when the fly wheel(s) 440 and drive gear 550 are appropriately powered and sufficient kinetic energy is established, the energy may be transferred from the fly wheel(s)/gear to anvil 102 via rack press 556 and rack 552. A return spring 558 is provided to return anvil 102 and rack 552 to an initial position subsequent to splitting operations. As will be recognized by one of skill in the art, return spring 558 should be of sufficient force/spring constant to return anvil 102 and rack 552 to an initial position without significantly impeding the driving force of anvil 102.

FIGS. 5A-5C further illustrate an embodiment where the rack press 556 and rack 552 are biased toward a disengaged position by a translatable rack spring 554. Rack spring 554 provides sufficient upward force to position rack 552 in a non-contacting position with respect to drive gear 550. As further shown, a roller 560 is provided to allow rack spring 554 to travel with rack 552. Roller 560 contacts a roller plate 562, such that rack spring 554 travels with rack 552 and anvil 102. In various embodiments, roller 560 may extend beyond the housing of fly wheel 440 during splitting operations. In various embodiments, rack spring 554 operates in combination with the previously discussed drive release biasing member 228. In one particular embodiment, rack spring 554 obviates the need for a drive release biasing member. In other words, rack spring 554 provides sufficient force to disengage rack 552 in at least one embodiment and the previously described drive release biasing member is not provided. It will be expressly recognized that the accompanying drawings are not necessarily to scale. Rollers and roller plates of various size and dimension are contemplated herein.

In accordance with the above, a method of splitting logs is provided comprising providing a log splitter comprising a log-supporting track having a first end and a second end; the first end of the track having a splitting wedge; the second end of the track having an anvil mounted to reciprocate along the track; the anvil fixedly attached to a rack member; the rack member in selective force-transmitting communication with a fly-wheel; the fly-wheel adapted to be driven by an engine; a first shaft having a safety release member, the first shaft hingedly connected to a lock member, the lock member and the hingedly connected first shaft biased toward a first position; a second shaft hingedly connected to a lever and oriented substantially perpendicular to the first shaft and biased in an upward direction; the lock member preventing downward displacement of the second shaft and the lever when the first shaft and the lock member are disposed in the first position; wherein a force-transmitting communication between the rack member and the fly-wheel is achieved by downward displacement of the second shaft; loading a material to be split between the anvil and the splitting wedge; applying a force to the safety release member to displace the safety release member and the first shaft from a first position to a second position; and applying a second force to the lever to place the rack member and the fly-wheel in force-transmitting communication and displace the anvil from a first position to a second position.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A log splitter comprising:
a safety release member operable by a first hand of a user; and
a splitter activation member operable by a second hand of the user,
wherein operation of both the safety release member and the splitter activation member are required to enable performance of log splitting operation of the log splitter.

2. The log splitter of claim 1, wherein the safety release member and the splitter activation member each comprise a user actuable element, the user actuable elements separated from each other a distance sufficient to prevent one-handed operation of both the safety release member and the splitter activation member.

3. The log splitter of claim 2, wherein the distance is at least about 12 inches.

4. The log splitter of claim 2, further comprising a housing containing one or more features of the log splitter, and wherein the user actuable elements of the safety release member and the splitter activation member are accessible from outside the housing.

5. The log splitter of claim 4, further comprising an aperture present on an exterior of the housing, wherein the safety release member is recessed at least partially within the aperture.

6. The log splitter of claim 1, wherein at least one of the safety release member and the splitter activation member is located distal from a location where the log splitting operation occurs.

7. The log splitter of claim 1, wherein the safety release member is part of a safety lock out mechanism, the safety lock out mechanism comprising:
a lock member, and
a lock out shaft coupled at a first end to the lock member and at a second end to the safety release member.

8. The log splitter of claim 7, wherein the lock member prevents actuation of the splitter activation member when the safety release member is in a non-actuated position.

9. The log splitter of claim 7, wherein actuation of the safety release member causes the lock member to move and permit actuation of the splitter activation member.

10. The log splitter of claim 7, wherein the lock member is angularly rotatable between a first position in which actuation of the splitter activation member is prevented and a second position in which actuation of the splitter activation member is permitted.

11. The log splitter of claim 10, wherein the lock member is biased in the first position by a biasing member.

12. The log splitter of claim 1, wherein the splitter activation member comprises a drive release member configured to trigger performance of the log splitting operation when the drive release member is actuated.

13. The log splitter of claim 12, further comprising a biasing member biasing the drive release member in a non-actuated position.

14. The log splitter of claim 13, wherein actuation of the drive release member requires use of force sufficient to overcome a biasing force provided by the biasing member.

15. A log splitter comprising:
a first shaft having a safety release member, the first shaft hingedly connected to a lock member, the lock member and the hingedly connected first shaft biased toward a first position;
a second shaft hingedly connected to a lever and oriented substantially perpendicular to the first shaft and biased in an upward direction;
the lock member preventing downward displacement of the second shaft and the lever when the first shaft and the lock member are disposed in the first position; and
wherein actuation of log splitting operation is achieved by downward displacement of the second shaft.

16. The log splitter of claim 15, wherein contact between the safety release member and the lever is necessary to permit downward displacement of the second shaft and actuation of the log splitting operation.

17. A method of splitting logs, comprising:
providing a log splitter comprising a log-supporting track having a first end and a second end;
the first end of the track having a splitting wedge;
the second end of the track having an anvil mounted to reciprocate along the track;
the anvil fixedly attached to a rack member;
the rack member in selective force-transmitting communication with a fly-wheel;
the fly-wheel adapted to be driven by an engine;
a first shaft having a safety release member, the first shaft hingedly connected to a lock member, the lock member and the hingedly connected first shaft biased toward a first position;
a second shaft hingedly connected to a lever and oriented substantially perpendicular to the first shaft and biased in an upward direction;
the lock member preventing downward displacement of the second shaft and the lever when the first shaft and the lock member are disposed in the first position;
wherein a force-transmitting communication between the rack member and the fly-wheel is achieved by downward displacement of the second shaft;
loading a material to be split between the anvil and the splitting wedge;
applying a force to the safety release member to displace the safety release member and the first shaft from a first position to a second position; and
applying a second force to the lever to place the rack member and the fly-wheel in force-transmitting communication and displace the anvil from a first position to a second position.
